(19) United States
(12) Patent Application Publication
(10) Pub. No.: US 2022/0109794 A1
(43) Pub. Date: Apr. 7, 2022

(54) INFORMATION PROCESSING DEVICE, METHOD, AND PROGRAM

(71) Applicant: SONY GROUP CORPORATION, TOKYO (JP)

(72) Inventors: KEI TAKAHASHI, TOKYO (JP); TSUYOSHI ISHIKAWA, TOKYO (JP); RYOUHEI YASUDA, TOKYO (JP)

(21) Appl. No.: 17/426,215

(22) PCT Filed: Jan. 23, 2020
(86) PCT No.: PCT/JP2020/002218

§ 371 Date: Jul. 28, 2021

(30) Foreign Application Priority Data
Feb. 6, 2019 (JP) 2019-019433

(51) Int. Cl. H04N 5/232; H04N 5/222

(52) U.S. Cl. CPC H04N 5/23299; H04N 5/23218; H04N 5/23216; H04N 5/2224

(57) ABSTRACT

The present technology relates to an information processing device, a method, and a program capable of reducing the visual load of a video.

An information processing device includes an input acquisition unit that acquires user input that designates a display range of a free-viewpoint video, and a control unit that controls a virtual camera that determines the display range of the free-viewpoint video on the basis of the user input. When the control unit changes an angle of view of the virtual camera from a first angle of view including a first target to a second angle of view including a second target, if at least one of pan rotation or tilt rotation of the virtual camera has a predetermined angular velocity, the control unit performs at least one of the pan rotation or the tilt rotation while moving the virtual camera away from the first target, and if the angular velocity of the pan rotation and the tilt rotation of the virtual camera is smaller than the predetermined angular velocity, the control unit performs at least one of the pan rotation or the tilt rotation while maintaining the distance between the virtual camera and the first target. The present technology can be applied to an information processing device.

### TECHNICAL FIELD

The present technology relates to an information processing device, a method, and a program, and more particularly to an information processing device, a method, and a program capable of reducing the visual load of a video.

### BACKGROUND ART

For example, by using the free-viewpoint video viewing technology, the user can view a content from a viewpoint from an arbitrary position in a 3D space.

On the other hand, for contents such as sports where the viewing target and story development are clear, not only can the viewpoint position of the content be directly designated by the user, but also the viewpoint position can be changed according to a camera path generated by the system. With this method, it is possible to present a satisfactory video to the user without any particular operation by the user.

A camera path indicates a temporal change in the position and imaging direction of a virtual camera when a content video is displayed as if it was captured by the virtual camera. In this case, the position of the virtual camera is the viewpoint position of the content.

The camera path may be automatically generated by the system, or in a case where an input operation such as designating a target of interest in the content is performed by the user, the camera path may be generated by the system in response to the input operation.

Here, consider the case where the system generates a camera path in response to a user input operation. For example, when a predetermined target is designated by the user, the system generates a camera path in which the viewpoint position is moved from one viewpoint position to another viewpoint position and the virtual camera is rotated at a constant angular velocity so that the target is kept within the angle of view of the virtual camera.

However, in this case, while the virtual camera is moving, a state may occur where not only is the target out of the angle of view, but also all other objects are out of the angle of view. In such a case, the user will feel dissatisfied with the presented content video.

Against this background, there has been proposed a technology for, in a case of generating a free-viewpoint video, for example, limiting the viewpoint position of a virtual camera so that one of multiple objects does not go out of the frame (see Patent Document 1, for example). In Patent Document 1, in FIG. 35, for example, the object is always kept within the frame, that is, within the angle of view by rotating the virtual camera with the predetermined object position as the rotation center.

Additionally, there has also been proposed a technology for moving a virtual camera in parallel according to the movement of a player who is the subject, so that the virtual camera is always positioned at a certain distance in front of the player even if the player changes his/her position or direction, for example (see Patent Document 2, for example).

As described above, if some subject is always within the angle of view of the virtual camera, it is possible to curb dissatisfaction with the presented content video.

### CITATION LIST

### Patent Document

Patent Document 1: Japanese Patent Application Laid-Open No. 2015-114716
Patent Document 2: Japanese Patent Application Laid-Open No. 2006-310936

### SUMMARY OF THE INVENTION

### Problems to be Solved by the Invention

However, in the above-mentioned technology, the load on the user when the user visually identifies the video is not considered. For this reason, when the system generates the camera path of the virtual camera, the visual load of the video may increase.

The present technology has been made in view of such a situation, and aims to reduce the visual load of a video.

### Solutions to Problems

An information processing device of one aspect of the present technology includes an input acquisition unit that acquires user input that designates a display range of a free-viewpoint video, and a control unit that controls a virtual camera that determines the display range of the free-viewpoint video on the basis of the user input. When the control unit changes an angle of view of the virtual camera from a first angle of view including a first target to a second angle of view including a second target in response to the user input, if at least one of pan rotation or tilt rotation of the virtual camera has a predetermined angular velocity, the control unit performs at least one of the pan rotation or the tilt rotation of the virtual camera while moving the virtual camera away from the first target, and if the angular velocity of the pan rotation and the tilt rotation of the virtual camera is smaller than the predetermined angular velocity, the control unit performs at least one of the pan rotation or the tilt rotation of the virtual camera while maintaining the distance between the virtual camera and the first target.

An information processing method or program of one aspect of the present technology includes the steps of acquiring user input that designates a display range of a free-viewpoint video, and when changing an angle of view of a virtual camera that determines the display range of the free-viewpoint video in response to the user input from a first angle of view including a first target to a second angle of view including a second target, if at least one of pan rotation or tilt rotation of the virtual camera has a predetermined angular velocity, performing at least one of the pan rotation or the tilt rotation of the virtual camera while moving the virtual camera away from the first target, and if the angular velocity of the pan rotation and the tilt rotation of the virtual camera is smaller than the predetermined angular velocity, performing at least one of the pan rotation or the tilt rotation of the virtual camera while maintaining the distance between the virtual camera and the first target.

In one aspect of the present technology, user input that designates a display range of a free-viewpoint video is acquired, and when changing an angle of view of a virtual camera that determines the display range of the free-viewpoint video in response to the user input from a first angle of view including a first target to a second angle of view including a second target, if at least one of pan rotation or tilt rotation of the virtual camera has a predetermined angular velocity, at least one of the pan rotation or the tilt rotation of the virtual camera is performed while moving the virtual camera away from the first target, and if the angular velocity of the pan rotation and the tilt rotation of the virtual camera is smaller than the predetermined angular velocity, at least one of the pan rotation or the tilt rotation of the virtual camera is performed while maintaining the distance between the virtual camera and the first target.

### BRIEF DESCRIPTION OF DRAWINGS

FIG. 1 is a diagram illustrating an example of a camera path.

FIG. 2 is a diagram illustrating generation of a camera path.

FIG. 3 is a diagram illustrating generation of a camera path.

FIG. 4 is a diagram illustrating generation of a camera path.

FIG. 5 is a diagram illustrating generation of a camera path.

FIG. 6 is a diagram illustrating generation of a camera path.

FIG. 7 is a diagram illustrating generation of a camera path.

FIG. 8 is a diagram showing a configuration example of a video viewing system.

FIG. 9 is a flowchart illustrating camera path generation processing.

FIG. 10 is a diagram illustrating generation of a camera path.

FIG. 11 is a diagram illustrating calculation of the pixel difference.

FIG. 12 is a flowchart illustrating camera path generation processing.

FIG. 13 is a flowchart illustrating camera path generation processing.

FIG. 14 is a diagram illustrating correction of a viewpoint position.

FIG. 15 is a block diagram showing a configuration example of a computer.

### MODE FOR CARRYING OUT THE INVENTION

Hereinafter, an embodiment to which the present technology is applied will be described with reference to the drawings.

### First Embodiment

<Camera Path Generation>

The present technology reduces the visual load of a video by appropriately combining the rotation and translation (parallel translation) of a virtual camera and rotating the virtual camera at a predetermined angular velocity or less when generating a camera path for a free-viewpoint video. The visual load of a video can cause so-called visually induced motion sickness, for example.

The present technology can be applied to a video viewing system using a head mounted display (HMD), for example, and can also be applied to a video viewing system using a display such as a television or a smartphone.

The video viewing system to which the present technology is applied assumes presentation of a video (hereinafter also referred to as free-viewpoint video) whose viewpoint position changes over time, such as a free-viewpoint content based on a live-action video and a game content including computer graphics (CG). Additionally, contents presented by the video viewing system include recorded content and real-time content.

For example, the content of a free-viewpoint video based on a live-action video is a content that allows the viewer to appreciate the video as if it was captured by a virtual camera at an arbitrary position in the space on the basis of videos captured by multiple cameras. That is, the content of a free-viewpoint video is a video content in which the position of the virtual camera is the viewpoint position and the direction in which the virtual camera is directed is the imaging direction.

The video viewing system may be provided with a device capable of detecting the action (movement) of the user who is the viewer when viewing the content.

Specifically, in a case where a video viewing system includes an HMD, for example, a position track system that acquires information indicating the orientation and position of the head of the user wearing the HMD, a system that detects the direction of the line-of-sight of the user by a camera, another sensor, or the like, and a system that detects the posture of the user by a camera, a time of flight (TOF) sensor, or the like may be provided.

In addition, the user's line-of-sight direction may be detected by a camera, another sensor, or the like attached to a television, for example. Moreover, the video viewing system may be provided with a remote controller or a game controller for transmitting the intention of the user who is the viewer to the video viewing system.

For example, in the video viewing system, the user can designate a subject (object) of interest by an input operation to a remote controller or a game controller, by the direction of the user's line-of-sight and the head, the direction of the user's body, and the like. In this case, the video viewing system moves the viewpoint position of the free-viewpoint video to a position where the target of interest designated by the user can be clearly seen.

Accordingly, for example, the user can operate a key on a remote controller or the like to move the viewpoint position so that the target is displayed larger, or look at a specific target to designate the target by his/her line-of-sight and move the viewpoint position to a position where the target can be clearly seen.

Moreover, in a case where the target moves in the free-viewpoint video, the viewpoint position may be moved so that the target is continuously included in the angle of view of the virtual camera. Additionally, in a case where the target is an object that keeps moving like a sports player, the viewpoint position of the free-viewpoint video is not fixed, and even after the target appears large enough in the displayed frame (image), the viewpoint position may continue to move according to the movement of the player.

Hereinbelow, the present technology will be described more specifically. In particular, in the following, the description will be continued by taking the case of generating a camera path of a free-viewpoint video in a video viewing system as an example.

A free-viewpoint video is, for example, a video (image) of an arbitrary display range in a space generated on the basis of videos captured by cameras at multiple different viewpoint positions and imaging directions.

Here, the display range of the free-viewpoint video is the range captured by the virtual camera in the space, that is, the range of the angle of view of the virtual camera, and this display range is determined by the position of the virtual camera in the space which is the viewpoint position, and the direction of the virtual camera, that is, the imaging direction of the virtual camera.

In a free-viewpoint video, the position (viewpoint position) and imaging direction of the virtual camera change over time.

For example, the viewpoint position, which is the position of the virtual camera in the space, is represented by the coordinates of a three-dimensional Cartesian coordinate system whose origin is a reference position in the space.

Additionally, for example, the imaging direction (direction) of the virtual camera in the space is represented by the rotation angle of the virtual camera from a reference direction in the space. That is, for example, the rotation angle indicating the imaging direction of the virtual camera is the rotation angle when the virtual camera is rotated from the state in which the virtual camera is facing the reference direction to the state in which the virtual camera is facing the desired imaging direction.

Note that more specifically, the rotation angle of the virtual camera includes the yaw angle, which is the rotation angle when the virtual camera is rotated in the horizontal (left-right) direction (pan rotation), and the pitch angle, which is a rotation angle when the virtual camera is rotated in the vertical (up-down) direction (tilt rotation). In the following, when it is described that the virtual camera rotates and the rotation angle changes, it is assumed that at least one of the yaw angle or the pitch angle changes.

Additionally, the viewpoint position and rotation angle of the virtual camera at a predetermined time are denoted by P0 and R0, and the viewpoint position and rotation angle of the virtual camera at a time after the predetermined time are denoted by P1 and R1.

At this time, the temporal change of the viewpoint position of the virtual camera and the temporal change of the rotation angle of the virtual camera when the rotation angle of the virtual camera is changed from R0 to R1 while moving the virtual camera from the viewpoint position P0 to the viewpoint position P1 form a camera path of the virtual camera starting from the viewpoint position P0 and ending at the viewpoint position P1.

More specifically, the temporal change of the viewpoint position of the virtual camera is determined by the movement path of the virtual camera and the movement speed of the virtual camera at each position on the movement path. Additionally, the temporal change of the rotation angle of the virtual camera is determined by the rotation angle and the rotation speed (angular velocity of rotation) of the virtual camera at each position on the movement path of the virtual camera.

In the following, in particular, the viewpoint position and rotation angle of the virtual camera at the start point of the camera path are denoted by P0 and R0, and the viewpoint position and rotation angle of the virtual camera at the end point of the camera path are denoted by P1 and R1.

Additionally, the state of the virtual camera having the viewpoint position P0 and the rotation angle R0 is also denoted by a state ST0, and the state of the virtual camera having the viewpoint position P1 and the rotation angle R1 is also denoted by a state ST1.

Now, assume that when the virtual camera is in the state ST0, a target T0 which is a predetermined subject of interest is included in the angle of view of the virtual camera.

In such a state ST0, consider a case where the user designates a target T1 which is a new subject of interest, and a camera path in which the state of the virtual camera changes from the state ST0 to the state ST1 is generated, for example. At this time, assume that the target T1 is included in the angle of view of the virtual camera in the state ST1.

For example, assume that a camera path is generated in which the rotation angle of the virtual camera rotates at a constant angular velocity from R0 to R1 when changing from the state ST0 to the state ST1.

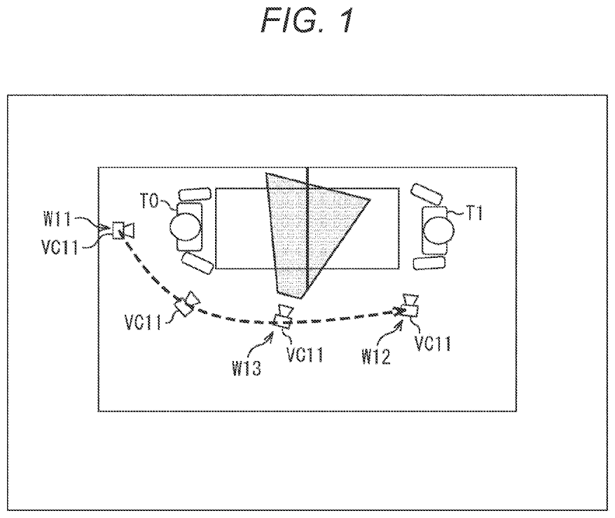

In this case, for example, as shown in FIG. 1, during the movement of a virtual camera VC11, a timing may occur in which neither the target T0 nor the target T1 is included in the angle of view of the virtual camera VC11.

In the example shown in FIG. 1, a video of a table tennis match in which the players are the target T0 and the target T1 is displayed as a free-viewpoint video. Additionally, in FIG. 1, the position indicated by an arrow W11 indicates the viewpoint position P0, the position indicated by an arrow W12 indicates the viewpoint position P1, and the dotted line indicates the movement path of the virtual camera VC11.

In this example, while the virtual camera VC11 moves from the position indicated by the arrow W11 to the position indicated by the arrow W12, the rotation angle of the virtual camera VC11, that is, the imaging direction changes at a constant angular velocity. In other words, the virtual camera VC11 rotates at a constant rotation speed.

In this case, for example, when the virtual camera VC11 is at the position indicated by an arrow W13, neither the target T0 nor the target T1 is included in the angle of view of the virtual camera VC11. Accordingly, neither the target T0 nor the target T1 appears in the displayed free-viewpoint video, and the user who is the viewer feels dissatisfaction.

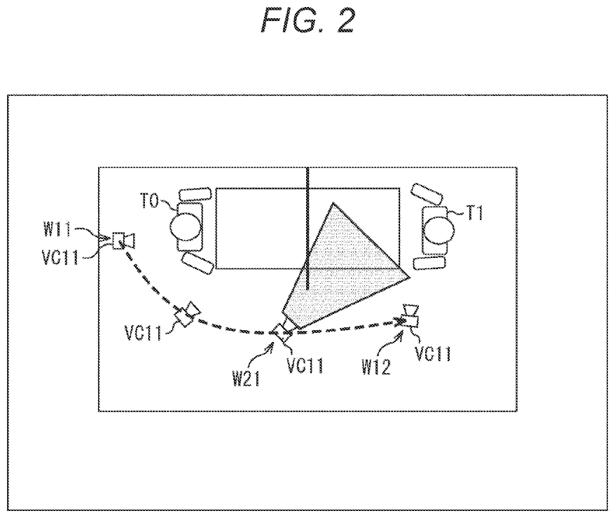

On the other hand, for example, if the target T1 is continuously included in the angle of view of the virtual camera VC11 in the latter half of the camera path as shown in FIG. 2, the dissatisfaction caused in the example shown in FIG. 1 can be solved, and the user's satisfaction with the free-viewpoint video can be improved. Note that in FIG. 2, the same reference numerals are given to the parts corresponding to those in FIG. 1, and the description thereof will be omitted as appropriate.

In the example shown in FIG. 2, a midpoint Pm is a predetermined position in the camera path while the virtual camera VC11 moves from the viewpoint position P0 indicated by the arrow W11 to the viewpoint position P1 indicated by the arrow W12. Here, the position indicated by an arrow W21 in the camera path is defined as the midpoint Pm.

In this case, the rotation angle is determined so that the target T1 is within the angle of view of the virtual camera VC11 at least when the virtual camera VC11 reaches the midpoint Pm. Then, the rotation angle at each position on the movement path of the virtual camera VC11 is determined so that the target T1 is always included in the angle of view of the virtual camera VC11 while the virtual camera VC11 moves from the midpoint Pm to the viewpoint position P1 in the camera path. In other words, the camera path is generated so that the virtual camera VC11 keeps facing the target T1 while moving from the midpoint Pm to the viewpoint position P1.

As a result, in the latter half of the camera path, that is, at each viewpoint position from the midpoint Pm onward, the user who is the viewer can keep watching the target T1 in the free-viewpoint video until the virtual camera VC11 reaches the viewpoint position P1 which is the end point. As a result, the user can view a satisfactory free-viewpoint video.

Additionally, in this case, while the virtual camera VC11 moves from the midpoint Pm to the viewpoint position P1, the virtual camera VC11 images the target T1 from various angles. Hence, the user can observe the target T1 from various angles in the free-viewpoint video. As a result, the satisfaction level of the free-viewpoint video can be further improved.

Here, the determination of the movement path of the virtual camera when generating the camera path will be described.

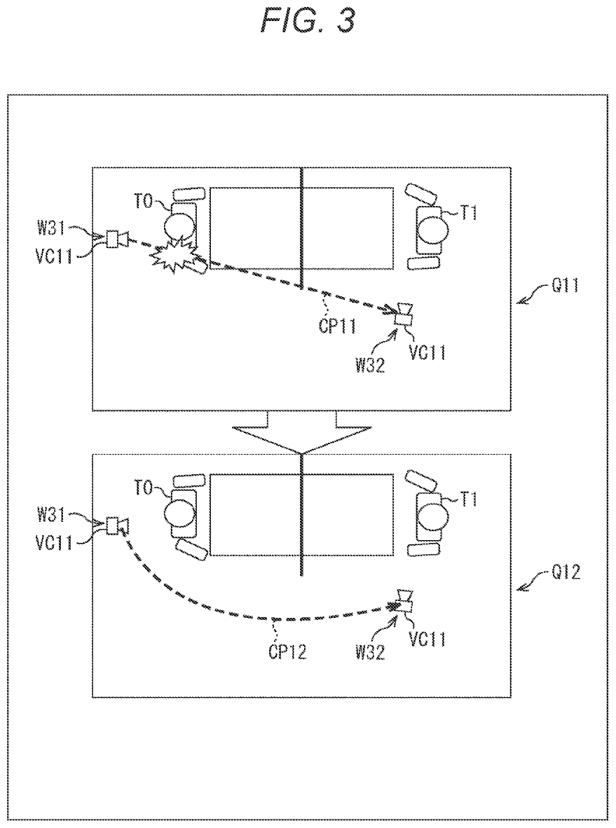

For example, as indicated by an arrow Q11 in FIG. 3, assume that a camera path is generated in which the virtual camera VC11 is moved linearly from the viewpoint position P0 indicated by an arrow W31 to the viewpoint position P1 indicated by an arrow W32. In FIG. 3, the same reference numerals are given to the parts corresponding to those in FIG. 1, and the description thereof will be omitted as appropriate.

In the example indicated by the arrow Q11, a straight line CP11 connecting the viewpoint position P0 and the viewpoint position P1 indicates the movement path included in the camera path of the virtual camera VC11. However, in this example, the straight line CP11 intersects the target T0, and the virtual camera VC11 will collide with the target T0 when the virtual camera VC11 moves.

Hence, for example, as indicated by an arrow Q12, a camera path is generated by assuming that a repulsion acts on the virtual camera VC11 from an object such as the target T0, that is, the virtual camera VC11 receives a repulsive force from the object such as the target T0.

In such a case, a model related to the repulsive force received by the virtual camera VC11 is prepared in advance for each object such as the target T0. When generating the camera path, the model related to repulsive force is used to obtain the camera path of the virtual camera VC11, more specifically, the movement path of the virtual camera VC11.

With this configuration, the movement speed of the virtual camera VC11 at the viewpoint position P0 or the like is appropriately adjusted, and the movement path is adjusted so that the virtual camera VC11 moves at a position a certain distance away from the object such as the target T0. As a result, for example, a movement path CP12 in which the viewpoint position P0 and the viewpoint position P1 are smoothly connected by a curve can be obtained.

Here, a more specific description will be given of generation of the camera path when the virtual camera VC11 receives a repulsion from an object such as the target T0, that is, when a model related to repulsive force is used.

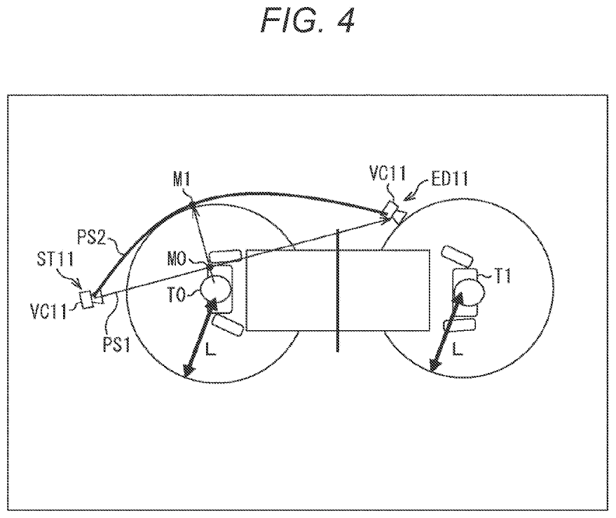

For example, as shown in FIG. 4, assume that the target T0 and the target T1 exist in a space, and a camera path for moving from the viewpoint position P0 to the viewpoint position P1 is generated. Note that in FIG. 4, the same reference numerals are given to the parts corresponding to those in FIG. 1, and the description thereof will be omitted as appropriate.

Here, the position indicated by an arrow ST11 is the viewpoint position P0 which is the start point of the camera path, and at the viewpoint position P0, the rotation angle of the virtual camera VC11 is R0. Additionally, the position indicated by an arrow ED11 is the viewpoint position P1 which is the end point of the camera path, and at the viewpoint position P1, the rotation angle of the virtual camera VC11 is R1.

Moreover, assume that the virtual camera VC11 moves from the viewpoint position P0 to the viewpoint position P1 while passing through a position at least a distance L away from a main object such as a human being. In this example, the main objects are the target T0 and the target T1.

In this case, the distance L to be separated from the target T0 and the target T1 is first determined. For example, the distance L may be predetermined, or may be determined from the sizes of the target T0 and the target T1 or the focal length of the virtual camera VC11. Such a distance L corresponds to a model related to repulsive force.

Next, a straight line connecting the viewpoint position P0 and the viewpoint position P1 is obtained as a path PS1, and the point M0 closest to the target on the path PS1 is searched. Here, of the target T0 and the target T1, the target T0 is located closer to the path PS1, and therefore the point (position) closest to the target T0 on the path PS1 is set as a point M0.

Moreover, when the point M0 is moved in a direction perpendicular to the path PS1 to a position separated from the target T0 by the distance L, the position after the movement is defined as a position M1. Then, the viewpoint position P0, the position M1, and the viewpoint position P1 are smoothly connected by a curve (path) such as a Bezier curve so that the curvature becomes continuous, and the resulting curve PS2 is defined as the movement path of the virtual camera VC11 that moves from the viewpoint position P0 to the viewpoint position P1. That is, the curve PS2 is the movement path included in the camera path of the virtual camera VC11.

In this case, the virtual camera VC11 moves from the viewpoint position P0 to the viewpoint position P1 through the position M1 while maintaining the state in which the distance from the object such as the target T0 is a certain distance L or more.

Note that there are many objects such as the target T0 in the space, and it may not be possible to appropriately determine the movement path by the above method. In such a case, for example, the movement path of the virtual camera VC11 may be determined so that the distance L is maintained with respect to at least the target T0 and the target T1, and in the actual free-viewpoint video, objects other than the target T0 and the target T1 may be displayed semi-transparently.

By generating the camera path as described above, the virtual camera VC11 can be moved from the viewpoint position P0 to the viewpoint position P1 while maintaining an appropriate distance from the objects such as the target T0 and the target T1. As a result, the virtual camera VC11 can be moved so as to go around the target T0 and the target T1 which are the targets of interest, and the user can observe the target T0 and the target T1 well from various angles in the free-viewpoint video.

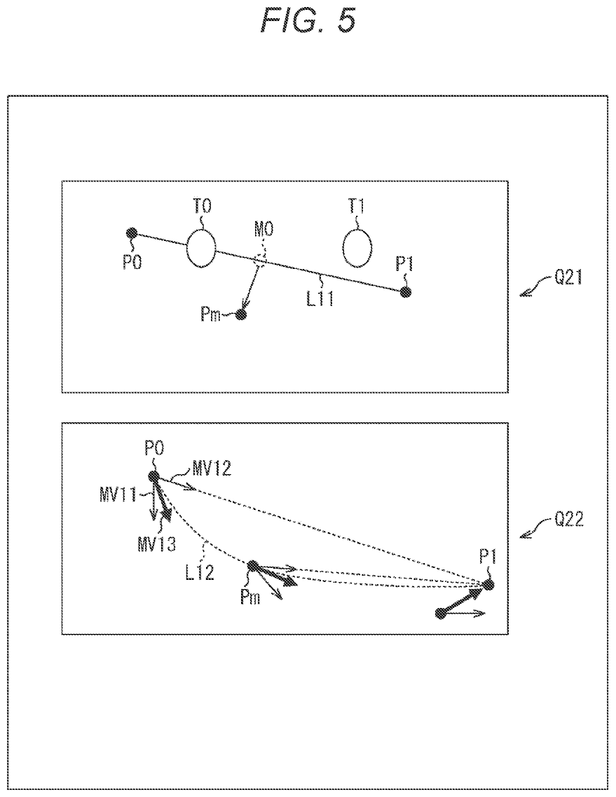

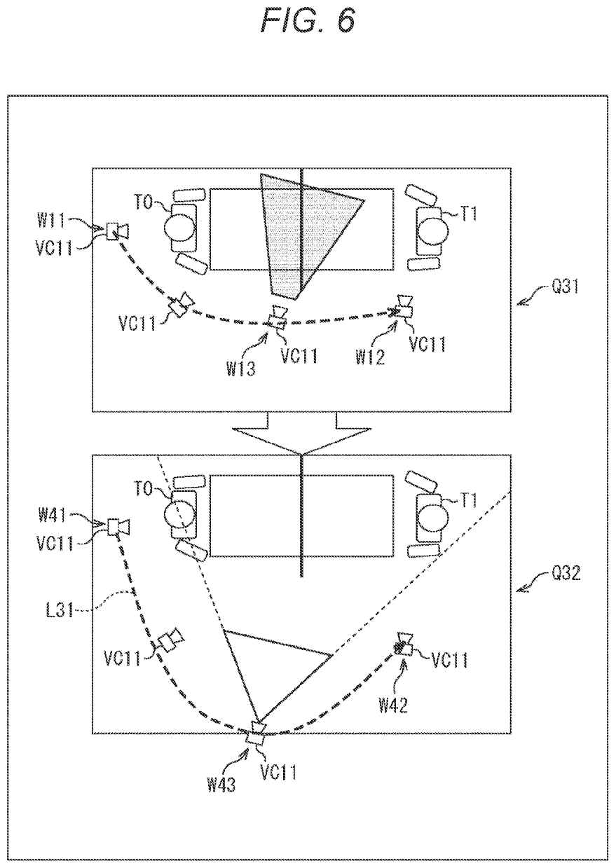

Moreover, with the method shown in FIGS. 5 and 6, for example, the camera path can be generated easier than the case of using the model related to repulsive force. Note that in FIGS. 5 and 6, the same reference numerals are given to the parts corresponding to those in FIG. 1, and the description thereof will be omitted as appropriate. Additionally, in FIG. 6, the same reference numerals are given to the parts corresponding to those in FIG. 5, and the description thereof will be omitted as appropriate.

In the example shown in FIG. 5, as indicated by an arrow Q21, an intermediate point M0 of a straight line L11 connecting the viewpoint position P0 which is the start point of the movement path of the virtual camera VC11 and the viewpoint position P1 which is the end point of the movement path is obtained.

Then, the intermediate point M0 is moved in a direction substantially perpendicular to the straight line L11 to a position sufficiently distant from the intermediate point M0, that is, to a position sufficiently distant from the target T0 and the target T1 so that the distance is equal to or greater than a predetermined distance. The position after the movement is defined as the midpoint Pm.

For example, the midpoint Pm is a position where the target T0 and the target T1 are included in the angle of view of the virtual camera VC11 when the virtual camera VC11 is arranged at the midpoint Pm at a predetermined rotation angle.

When the midpoint Pm is determined in this way, a curve L12 that smoothly connects the viewpoint position P0, the midpoint Pm, and the viewpoint position P1 is obtained as indicated by an arrow Q22, and the obtained curve L12 is defined as the movement path of the virtual camera VC11 included in the camera path.

In particular, when obtaining the movement path of the virtual camera VC11, a speed obtained by combining the original movement speed of the virtual camera VC11 and the speed at which the virtual camera VC11 heads for the destination, that is, the speed at which the virtual camera VC11 moves from the viewpoint position P0 to the viewpoint position P1 is defined as the movement speed of the virtual camera VC11 at each position on the moving path.

Specifically, for example, an arrow MV11 represents the original movement speed of the virtual camera VC11 at the viewpoint position P0, and this movement speed is the speed of the virtual camera VC11 at the viewpoint position P0 when the virtual camera VC11 moves from another position to the viewpoint position P0.

Additionally, an arrow MV12 represents the speed at which the virtual camera VC11 moves to the viewpoint position P1 which is the destination, and this speed is obtained by the video viewing system on the basis of the viewpoint position P0, the viewpoint position P1, and the like.

When generating the camera path, the movement speed represented by the arrow MV11 and the movement speed represented by the arrow MV12 as described above are combined, and the combined movement speed is defined as the movement speed of the virtual camera VC11 at the viewpoint position P0 in the camera path. In FIG. 5, an arrow MV13 represents the movement speed obtained by combining the movement speed represented by the arrow MV11 and the movement speed represented by the arrow MV12.

Additionally, for example, as indicated by an arrow Q31 in FIG. 6, when the subject of interest is switched from the target T0 to the target T1, and the virtual camera VC11 is rotated evenly from the start point to the end point of the camera path, that is, at a constant angular velocity, there is a timing when neither the target T0 nor the target T1 is included in the angle of view of the virtual camera VC11.

In the example indicated by an arrow Q31, the position indicated by an arrow W11 is the viewpoint position P0, and the position indicated by an arrow W12 is the viewpoint position P1. When the subject of interest is switched from the target T0 to the target T1, the virtual camera VC11 moves from the viewpoint position P0 to the viewpoint position P1. At this time, for example, at the position indicated by an arrow W13, neither the target T0 nor the target T1 is included in the angle of view of the virtual camera VC11.

Hence, for example, as indicated by an arrow Q32, when the subject of interest is switched from the target T0 to the target T1, a camera path is generated so as to enable viewing of both the old and new subjects of interest, the target T0 and the target T1.

For example, assume that from a state in which the subject of interest is the target T0, the target T1 is designated as a new subject of interest by a user input operation or the like.

In this case, assume that the viewpoint position and rotation angle of the virtual camera VC11 are P0 and R0 at the start point of the camera path, and the viewpoint position and rotation angle of the virtual camera VC11 are P1 and R1 at the end point of the camera path. Here, the position indicated by an arrow W41 is the viewpoint position P0, and the position indicated by an arrow W42 is the viewpoint position P1.

In the example indicated by the arrow Q32, too, the midpoint Pm is determined in a similar manner as in FIG. 5, for example. In particular, here, the position indicated by an arrow W43 is the midpoint Pm.

The midpoint Pm is a position where the distance from the target T0 and the distance from the target T1 are equivalent, and the target T0 and the target T1 are included in the angle of view of the virtual camera VC11 when the virtual camera VC11 is placed at the midpoint Pm.

When the midpoint Pm is determined in this way, a camera path is obtained in which the movement path is a curve that smoothly connects the viewpoint position P0, the midpoint Pm, and the viewpoint position P1. In the part indicated by the arrow Q32, a curve L31 represents the movement path of the virtual camera VC11 included in the camera path.

Here, during the first half of the movement of the virtual camera VC11 according to the camera path, that is, when moving from the viewpoint position P0 to the midpoint Pm, the movement path, movement speed, rotation angle, and rotation speed of the virtual camera VC11 are determined so that at least the target T0 is continuously kept within the angle of view of the virtual camera VC11. In particular, when the virtual camera VC11 is in the vicinity of the midpoint Pm, both the target T0 and the target T1 are included in the angle of view of the virtual camera VC11.

Additionally, during the latter half of the movement of the virtual camera VC11 according to the camera path, that is, when moving from the midpoint Pm to the viewpoint position P1, the movement path, movement speed, rotation angle, and rotation speed of the virtual camera VC11 are determined so that at least the target T1 is virtually kept within the angle of view of the virtual camera VC11.

As a result, when the viewpoint is moved, that is, when the virtual camera VC11 is moved, the user who views the free-viewpoint video generated according to the camera path can see the target T0 in the first half of the movement, see both the target T0 and the target T1 in the middle of the movement, and see the target T1 in the latter half of the movement.

<Present Technology>

Incidentally, if the camera path is generated as described above, when the subject of interest changes from the target T0 to the target T1, the target T0 or the target T1 stays in the field of view, that is, the angle of view of the virtual camera even while the virtual camera is moving. As a result, it is possible to continue to present a meaningful video as a free-viewpoint video.

However, in a case where the rotation angle of the virtual camera changes significantly in the camera path, that is, in a case where the rotation speed, which is the angular velocity of the rotation of the virtual camera, is large, visually induced motion sickness may occur.

Specifically, for example, when a user wears an HMD and is viewing a free-viewpoint video, assume that the viewpoint position of the virtual camera is moved independently of the movement of the user's head. In such a case, the visually induced motion sickness that occurs when the virtual camera is rotated becomes larger than that when the virtual camera is moved in translation. In particular, if the virtual camera rotates largely while the viewpoint position and the target of interest are close to each other, the visually induced motion sickness becomes even more severe.

Accordingly, when generating a camera path, it is desirable that the virtual camera does not rotate at a certain rotation speed (angular velocity) or higher when the viewpoint is moved.

Hence, in the present technology, it is possible to reduce visually induced motion sickness by generating a camera path so that the rotation speed of the virtual camera is equal to or less than a predetermined threshold value th. That is, the visual load of the video can be reduced.

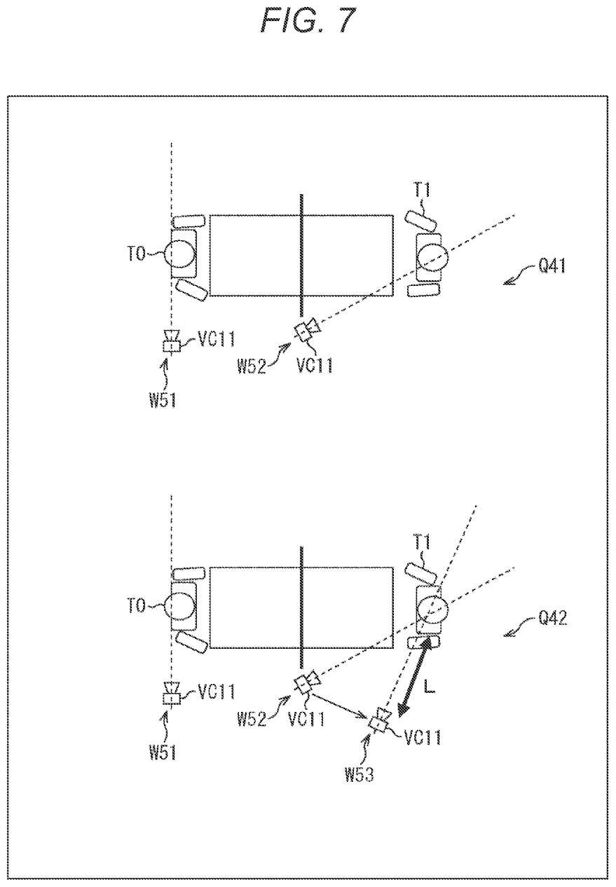

Specifically, assume that the absolute amount of rotation, more specifically, the upper limit of the rotation speed of the virtual camera when changing from the state ST0 to the state ST1 is determined so that the rotation speed becomes equal to or less than the threshold value th, for example. In such a case, a camera path is generated as shown in FIG. 7, for example. Note that In FIG. 7, the same reference numerals are given to the parts corresponding to those in FIG. 1, and the description thereof will be omitted as appropriate.

For example, as indicated by an arrow Q41 in FIG. 7, assume that the target T0 and the target T1 are in a space, and a camera path is generated in which the angle of view of the virtual camera VC11 changes from the state in which the target T0 is included in the angle of view to the state in which the target T1 is included in the angle of view. In other words, the angle of view of the virtual camera VC11 is changed from the angle of view including the target T0 to the angle of view including the target T1.

At this time, assume that the movement of the virtual camera VC11 is completed in one second, and the average value of the rotation speed of the virtual camera VC11 is 30 degrees/second at the maximum. That is, assume that the threshold value th=30 degrees/sec. For example, the threshold value th is determined on the basis of whether or not visually induced motion sickness occurs. If the average rotation speed of the virtual camera VC11 is equal to or less than the threshold value th, the camera work is less likely to cause visually induced motion sickness.

Moreover, assume that in the angle of view of the virtual camera VC11, when the distance from the target T1 to the virtual camera VC11 is L, the target T1 appears in an appropriate size on the free-viewpoint video.

Moreover, at the start point of the camera path, the virtual camera VC11 is at the position indicated by an arrow W51, and that position is the viewpoint position P0.

Additionally, assume that when the virtual camera VC11 is at the viewpoint position P0, the rotation angle of the virtual camera VC11 is R0=0 degrees.

From such a state, when a new target T1 is designated, the state at the end point of the camera path, that is, the viewpoint position P1 and the rotation angle R1 of the virtual camera VC11 after movement are determined, so that the target T1 in an appropriate size is included in the angle of view.

In the example indicated by the arrow Q41, the position indicated by an arrow W52 is the viewpoint position P1. For example, the viewpoint position P1 is a position separated from the new target T1 by a distance L.

Additionally, the rotation angle R1 of the virtual camera VC11 at the viewpoint position P1 is, for example, a rotation angle at which the target T1 can be captured (imaged) from substantially the front by the virtual camera VC11. For example, the rotation angle R1 is determined on the basis of the orientation and the like of the target T1. As a specific example, the rotation angle R1 can be determined so that the angle formed by the front direction seen from the target T1 and the optical axis of the virtual camera VC11 is equal to or less than a predetermined threshold value, for example.

Here, assuming that the determined rotation angle R1 is 60 degrees, the rotation angle of the virtual camera VC11 changes by 60 degrees before and after the movement from the viewpoint position P0 to the viewpoint position P1. That is, the virtual camera VC11 rotates by 60 degrees.

In this case, if the movement from the viewpoint position P0 to the viewpoint position P1 is to be completed in one second, the average rotation speed of the virtual camera VC11 becomes 60 degrees/second, which is larger than the threshold value th. That is, the camera work is likely to cause visually induced motion sickness.

Hence, the viewpoint position P1 and the rotation angle R1 after the movement of the virtual camera VC11 are recalculated so that the average rotation speed of the virtual camera VC11 is equal to or less than the threshold value th. In the following, the recalculated, that is, redetermined, viewpoint position P1 and rotation angle R1 of the virtual camera VC11 will be denoted by a viewpoint position P1′ and a rotation angle R1′ in particular.

When obtaining the viewpoint position P1′ and the rotation angle R1′, the rotation angle R1′ is first obtained so that the average rotation speed of the virtual camera VC11 is equal to or less than the threshold value th. Here, rotation angle R1′=30 degrees, for example.

Then, as indicated by an arrow Q42, with respect to the rotation angle R1′, a position where the virtual camera VC11 can capture (image) the target T1 from an appropriate angle such as substantially the front and the distance from the target T1 is L is obtained as the viewpoint position P1′, for example. At this time, for example, a position separated from the target T1 by a distance L in the direction opposite to the rotation angle R1′ can be defined as the viewpoint position P1′. In the example indicated by the arrow Q42, the position indicated by an arrow W53 is the viewpoint position P1′.

According to the viewpoint position P1′ and the rotation angle R1′ redetermined in this way, the rotation of the virtual camera VC11 before and after the movement, that is, the change in the rotation angle is curbed to 30 degrees. As a result, the average rotation speed of the virtual camera VC11 becomes 30 degrees/sec, which is equal to or less than the threshold value th. Thus, it is possible to achieve camera work that is less likely to cause visually induced motion sickness.

When the viewpoint position P1′ and the rotation angle R1′ after movement are determined, a camera path of the virtual camera VC11 that changes from the viewpoint position P0 and the rotation angle R0 to the viewpoint position P1′ and the rotation angle R1′ is generated. At this time, as described with reference to FIGS. 3, 4, 5, and 6, for example, the movement path and the movement speed of the virtual camera VC11 are determined so that the virtual camera VC11 moves from the viewpoint position P0 to the viewpoint position P1′.

Note that while it has been described in this example that the movement of the virtual camera VC11 is completed in one second, how many seconds it takes to complete the movement of the virtual camera VC11 may be appropriately determined according to the distance or the like between the target T0 and the target T1, for example.

Note, however, that it is desirable to complete the movement of the virtual camera VC11 in as short a time as possible. For example, the user designates a new target T1 and instructs the movement of the viewpoint position because there is some event that the user is interested in and he/she wants to see the target T1 related to the event. For example, in an actual sports game, the duration of the event is not long, so it is necessary to complete the movement of the virtual camera VC11 in a short time.

On the other hand, if the movement speed of the virtual camera VC11 is too fast, the user may not be able to grasp his/her position in the space, that is, the viewpoint position of the virtual camera VC11, or may have visually induced motion sickness. Hence, it is necessary to generate a camera path in which the movement is completed within a certain time, visually induced motion sickness is unlikely to occur, and the user can easily grasp his/her position and movement direction. Against this background, in the present technology, the camera path is generated so that the movement is completed in a short time and the average rotation speed of the virtual camera VC11 is equal to or less than the threshold value th.

<Configuration Example of Video Viewing System>

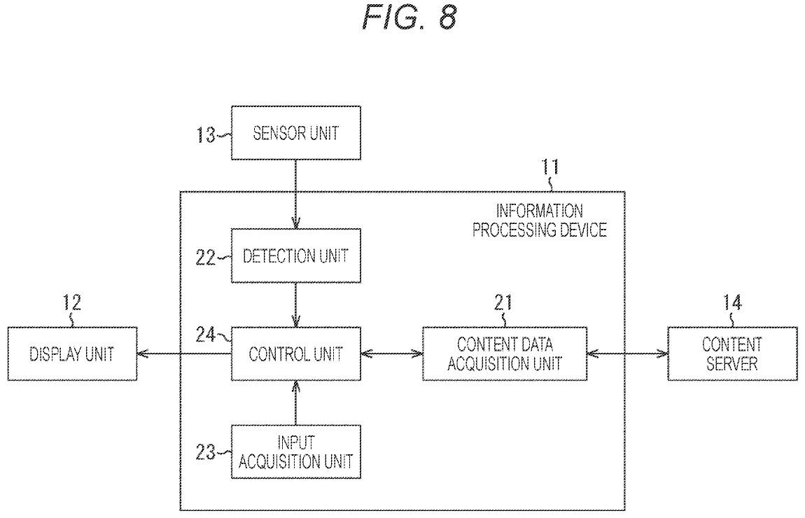

Subsequently, a configuration example of a video viewing system that generates a camera path as shown in FIG. 7 will be described. Such a video viewing system is configured as shown in FIG. 8, for example.

The video viewing system shown in FIG. 8 includes an information processing device 11, a display unit 12, a sensor unit 13, and a content server 14.

Here, for example, the information processing device 11 may include a personal computer, a game machine body, or the like, and the display unit 12 and the sensor unit 13 may include an HMD, or the information processing device 11 to the sensor unit 13 may be used to form an HMD or a smartphone.

Alternatively, the display unit 12 can include a television. Moreover, at least one of the display unit 12 or the sensor unit 13 may be provided in the information processing device 11. Note that in the following, the description will be continued assuming that the user who views the free-viewpoint video is wearing the display unit 12 and the sensor unit 13.

The information processing device 11 acquires content data for generating a free-viewpoint video from the content server 14, and also generates image data of the free-viewpoint video according to the output of the sensor unit 13 on the basis of the acquired content data to supply the image data to the display unit 12.

The display unit 12 has a display device such as a liquid crystal display, and reproduces a free-viewpoint video on the basis of the image data supplied from the information processing device 11.

The sensor unit 13 includes, for example, a gyro sensor, a TOF sensor, a camera, or the like for detecting the user's posture, head orientation, line-of-sight direction, and the like, and supplies the information processing device 11 with output of the gyro sensor or the TOF sensor, an image captured by the camera, or the like as sensor output.

The content server 14 holds as content data a group of image data of contents imaged from different viewpoints used for generating (constructing) a free-viewpoint video, and supplies the content data to the information processing device 11 in response to a request by the information processing device 11. That is, the content server 14 functions as a server that distributes free-viewpoint video.

Additionally, the information processing device 11 has a content data acquisition unit 21, a detection unit 22, an input acquisition unit 23, and a control unit 24.

The content data acquisition unit 21 acquires content data from the content server 14 according to the instruction of the control unit 24 and supplies the content data to the control unit 24. For example, the content data acquisition unit 21 acquires content data from the content server 14 by communicating with the content server 14 through a wired or wireless communication network. Note that the content data may be acquired from a removable recording medium or the like.

The detection unit 22 detects the posture, head orientation, and line-of-sight direction of the user wearing the display unit 12 and the sensor unit 13 on the basis of the sensor output supplied from the sensor unit 13, and supplies the detection result to the control unit 24.

For example, the detection unit 22 detects the user's posture and head orientation on the basis of the output of the gyro sensor or the TOF sensor as sensor output. Additionally, for example, the detection unit 22 detects the user's line-of-sight direction on the basis of an image as sensor output captured by the camera.

The input acquisition unit 23 includes, for example, a mouse, a keyboard, buttons, switches, a touch panel, a controller, and the like, and supplies the control unit 24 with a signal corresponding to a user's operation on the input acquisition unit 23. For example, the user performs a new target T1 designation operation or the like by operating the input acquisition unit 23.

The control unit 24 includes a central processing unit (CPU), a random access memory (RAM), and the like, for example, and controls the operation of the entire information processing device 11.

For example, the control unit 24 determines the display range of the free-viewpoint video by controlling the movement and rotation of the virtual camera, and generates image data of the free-viewpoint video according to the determination. Here, determining the camera path of the virtual camera corresponds to controlling the movement and rotation of the virtual camera.

Specifically, the control unit 24 generates a camera path of the free-viewpoint video on the basis of the detection result supplied from the detection unit 22 and the signal supplied from the input acquisition unit 23. Additionally, for example, the control unit 24 instructs the content data acquisition unit 21 to acquire content data, or generates image data of the free-viewpoint video on the basis of the generated camera path and the content data supplied from the content data acquisition unit 21 to supply the image data to the display unit 12.

<Description of Camera Path Generation Processing>

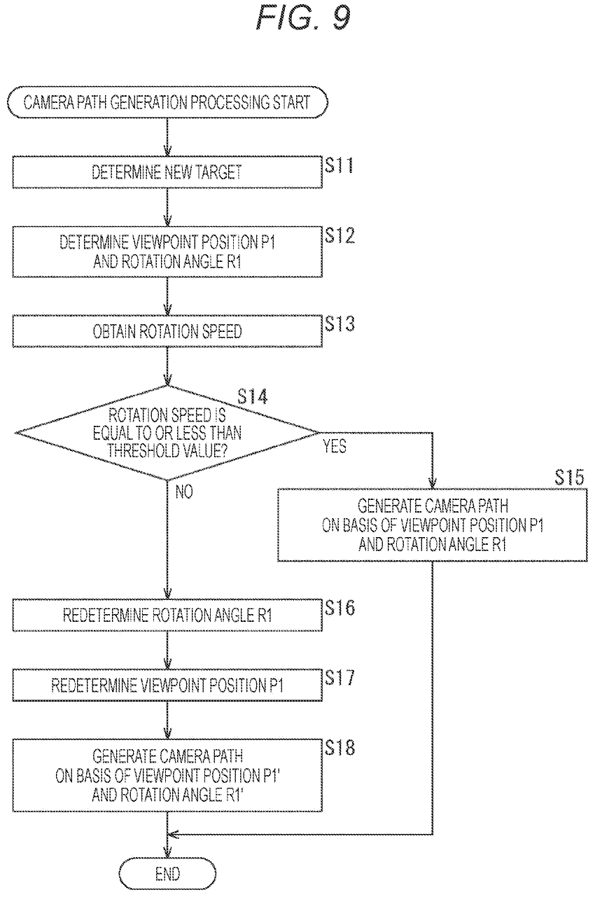

Next, the operation of the information processing device 11 will be described. That is, camera path generation processing performed by the information processing device 11 will be described below with reference to the flowchart of FIG. 9.

Note that the camera path generation processing is started when a new target T1 is designated by the user. The target T1 may be designated by the user operating the input acquisition unit 23, or by the user directing the line-of-sight, the head, the body, or the like to the target T1 in the free-viewpoint video, for example.

Additionally, assume that at the start of the camera path generation processing, the state of the virtual camera that determines the display range of the free-viewpoint video in the space is the above-mentioned state ST0, and the target T0 is included in the angle of view of the virtual camera. That is, assume that the virtual camera is located at the viewpoint position P0 and the rotation angle of the virtual camera is R0.

In step S11, the control unit 24 determines a new target T1 on the basis of a signal supplied from the input acquisition unit 23 or the detection result of the direction of the line-of-sight, head, body, or the like supplied from the detection unit 22.

For example, in a case where the user designates the target T1 by operating the input acquisition unit 23, the control unit 24 determines a new target T1 on the basis of the signal supplied from the input acquisition unit 23 in response to the user's input operation.

Additionally, for example, in a case where the user designates the target T1 by directing the line-of-sight, the head, the body, or the like to the target T1, the control unit 24 determines a new target T1 on the basis of the detection result of the user's line-of-sight direction or the like supplied from the detection unit 22.

The user designating a new target T1 in this way is equivalent to the user designating a new display range of the free-viewpoint video, that is, the angle of view of the virtual camera.

Accordingly, in a case where the user designates the target T1 by operating the input acquisition unit 23, it can be said that the input acquisition unit 23 functions as an input acquisition unit that acquires the user input that designates a new display range of the free-viewpoint video according to the user's operation and supplies the user input to the control unit 24.

Similarly, in a case where the user designates the target T1 by the line-of-sight or the like, the detection unit 22 functions as an input acquisition unit that acquires the user input that designates a new display range of the free-viewpoint video according to the user's operation.

In step S12, the control unit 24 determines the viewpoint position P1 and the rotation angle R1 of the virtual camera that enable appropriate observation of the target T1 in response to the determination of the new target T1. In other words, the control unit 24 determines the angle of view of the virtual camera after movement according to the target T1 determined on the basis of the user input acquired by the input acquisition unit 23 or the detection unit 22.

For example, in the space, the control unit 24 defines a position where the target T1 can be observed from the substantial front and which is separated from the target T1 by the aforementioned distance L as the viewpoint position P1, and defines a rotation angle at which the target T1 can be captured from the substantial front in the viewpoint position P1 as R1.

Note that in step S11, the user may be allowed to designate the viewpoint position P1 and the rotation angle R1 together with the target T1.

In step S13, the control unit 24 obtains an average rotation speed rot when the virtual camera moves from the viewpoint position P0 to the viewpoint position P1 on the basis of the viewpoint position P0 and the rotation angle R0 before the movement of the virtual camera and the viewpoint position P1 and the rotation angle R1 after the movement of the virtual camera.

That is, the control unit 24 obtains the rotation speed rot on the basis of the standard required time for moving the virtual camera from the viewpoint position P0 to the viewpoint position P1, the rotation angle R0, and the rotation angle R1. This rotation speed rot is the average angular velocity when the virtual camera is rotated. Note that here, the standard required time may be a predetermined time, or the standard required time may be obtained on the basis of the distance from the viewpoint position P0 to the viewpoint position P1.

In step S14, the control unit 24 determines whether or not the rotation speed rot obtained in step S13 is equal to or less than a predetermined threshold value th.

More specifically, in step S14, if the rotation speed rot of the pan rotation, that is, the rotation speed in the horizontal direction is equal to or less than the threshold value th, and the rotation speed rot of the tilt rotation, that is, the rotation speed in the vertical direction is equal to or less than the threshold th, it is determined that the rotation speed rot is equal to or less than the threshold th. Note that different threshold values th may be used for the pan rotation and the tilt rotation.

If it is determined in step S14 that the rotation speed rot is equal to or less than the threshold value th, the virtual camera rotates sufficiently slowly and visually induced motion sickness is less likely to occur, so the processing proceeds to step S15.

In step S15, the control unit 24 generates a camera path on the basis of the viewpoint position P1 and the rotation angle R1 determined in step S12, and the camera path generation processing ends.

In step S15, a camera path is generated in which the virtual camera moves from the viewpoint position P0 to the viewpoint position P1, and the virtual camera rotates from the direction indicated by the rotation angle R0 to the direction indicated by the rotation angle R1. For example, when generating the camera path, the movement path and movement speed of the virtual camera are determined as described with reference to FIGS. 3, 4, 5, and 6 described above.

On the other hand, if it is determined in step S14 that the rotation speed rot is not equal to or less than the threshold value th, that is, larger than the threshold value th, the rotation of the virtual camera is fast and there is a possibility that visually induced motion sickness may occur, so the processing proceeds to step S16.

In step S16, the control unit 24 redetermines the rotation angle R1 after movement. That is, the rotation angle R1′ described above is determined.

For example, the control unit 24 obtains a rotation angle R1′ so that the rotation speed rot is equal to or less than the threshold value th, on the basis of the upper limit value of the rotation speed of the virtual camera and the standard required time required for moving the virtual camera. In this case, the rotation angle R1′ is obtained so that |R1−R0|>|R1′−R0|.

In step S17, the control unit 24 redetermines the viewpoint position P1 after movement so that the target T1 appears in an appropriate size on the free-viewpoint video. That is, the viewpoint position P1′ described above is determined.

For example, the control unit 24 defines a position separated from the target T1 by a distance L in the direction opposite to the rotation angle R1′ as the viewpoint position P1′.

When the viewpoint position P1′ and the rotation angle R1′ are determined in this way, the angle of view after the movement of the virtual camera is redetermined.

In step S18, the control unit 24 generates a camera path on the basis of the viewpoint position P1′ and the rotation angle R1′, and the camera path generation processing ends.

In step S18, a camera path is generated in which the virtual camera moves from the viewpoint position P0 to the viewpoint position P1′, and the virtual camera rotates from the direction indicated by the rotation angle R0 to the direction indicated by the rotation angle R1′. For example, when generating the camera path, the movement path and movement speed of the virtual camera are determined as described with reference to FIGS. 3, 4, 5, and 6 described above.

In the camera path obtained in this way, not only can the target T1 be captured by the virtual camera in an appropriate size and orientation at the viewpoint position P1′ after movement, but also the average rotation speed of the virtual camera is equal to or less than the threshold value th. Hence, it is possible to reduce visually induced motion sickness.

When the processing of step S15 or step S18 is performed to generate the camera path, the control unit 24 determines the image data of the free-viewpoint video according to the generated camera path on the basis of the content data acquired by the content data acquisition unit 21.

That is, image data of a free-viewpoint video is generated when the virtual camera moves along the movement path indicated by the camera path and the direction of the virtual camera changes from the rotation angle R0 to the rotation angle R1 or the rotation angle R1′. In other words, image data of a free-viewpoint video whose display range changes so as to correspond to a change in the angle of view of the virtual camera according to the camera path is generated.

As described above, the information processing device 11 determines the viewpoint position and the rotation angle after the movement of the virtual camera so that the average rotation speed of the virtual camera is equal to or less than the threshold value th, and generates a camera path according to the determination. As a result, it is possible to reduce visually induced motion sickness of the free-viewpoint video.

Note that in steps S15 and S18 of the camera path generation processing described with reference to FIG. 9, for example, the movement path and movement speed of the virtual camera are determined as described with reference to FIGS. 3, 4, 5, and 6.

For example, in a case where the movement path is determined as described with reference to FIG. 6, the midpoint Pm (hereinafter also referred to as viewpoint position Pm) in which the target T0 and the target T1 are included in the angle of view and a rotation angle Rm of the virtual camera at the viewpoint position Pm may be determined. This viewpoint position Pm is a viewpoint position during the movement of the virtual camera from the viewpoint position P0 to the viewpoint position P1′.

In this case, for example, in step S18, the viewpoint position Pm and the rotation angle Rm of the virtual camera are determined on the basis of the viewpoint position P0 and the rotation angle R0 at the start point of the camera path and the viewpoint position P1′ and the rotation angle R1′ at the end point of the camera path. In other words, the angle of view of the virtual camera defined by the viewpoint position Pm and the rotation angle Rm is determined.

Here, the viewpoint position Pm can be, for example, a position that is separated from the original target T0 by a predetermined distance or more, and is equidistant from the target T0 and the target T1.

Additionally, the viewpoint position Pm is a position where the rotation of the virtual camera is reduced when the virtual camera moves from the viewpoint position P0 to the viewpoint position P1′ through the viewpoint position Pm. More specifically, for example, the viewpoint position Pm is a position where the angle of rotation when the virtual camera is rotated to change from the state in which the target T0 is included in the angle of view of the virtual camera to the state in which the target T1 is included in the angle of view of the virtual camera at the viewpoint position Pm is within a certain angle.

When the viewpoint position Pm and the rotation angle Rm are determined, the control unit 24 generates a camera path for smoothly moving from the viewpoint position P0 to the viewpoint position Pm while the direction of the virtual camera changes from the rotation angle R0 to the rotation angle Rm, and then smoothly moving from the viewpoint position Pm to the viewpoint position P1′ while the direction of the virtual camera changes from the rotation angle Rm to the rotation angle R1′.

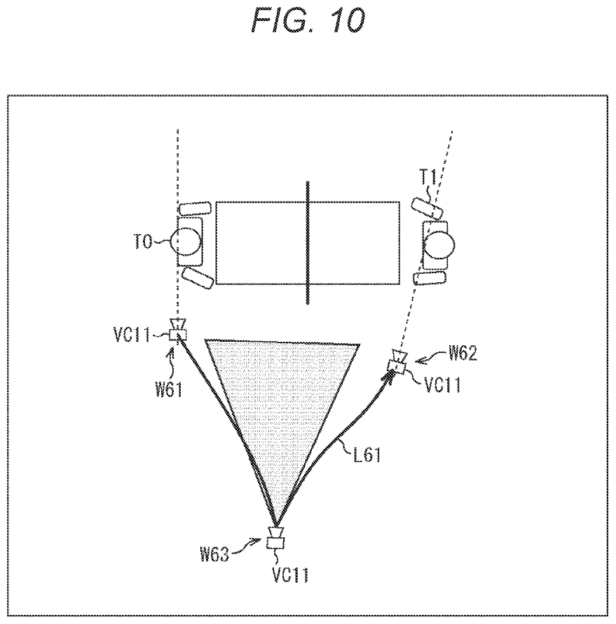

As a result, for example, the camera path shown in FIG. 10 is generated. Note that in FIG. 10, the same reference numerals are given to the parts corresponding to those in FIG. 6, and the description thereof will be omitted as appropriate.

In FIG. 10, a curve L61 represents the camera path generated by the control unit 24, and more specifically, the movement path of the virtual camera VC11. In particular, the position indicated by an arrow W61 indicates the viewpoint position P0 which is the start point of the movement path, and the position indicated by an arrow W62 indicates the viewpoint position P1′ which is the end point of the movement path. Additionally, the position indicated by an arrow W63 indicates the viewpoint position Pm.

In such a camera path, in the first half of the camera path, the control unit 24 controls the movement and rotation of the virtual camera so that the state in which the original target T0 is included in the angle of view of the virtual camera VC11 at the viewpoint position P0 changes to the state in which the target T0 and the target T1 are included in the angle of view of the virtual camera VC11 at the viewpoint position Pm.

In particular, at this time, the control unit 24 rotates the virtual camera VC11 while moving the virtual camera VC11 away from the target T0, that is, so that the distance from the target T0 to the virtual camera VC11 becomes longer. When the virtual camera VC11 is rotated, at least one of pan rotation or tilt rotation is performed.

When the virtual camera VC11 reaches the viewpoint position Pm, the target T0 and the target T1 are included in the angle of view of the virtual camera VC11. Then, in the latter half of the camera path, the control unit 24 controls the movement and rotation of the virtual camera so that the state in which the virtual camera VC11 is at the viewpoint position Pm changes to the state in which the target T1 is included in the angle of view of the virtual camera VC11 at the viewpoint position P1′.

In particular, at this time, the control unit 24 rotates the virtual camera VC11 while moving the virtual camera VC11 closer to the target T1, that is, so that the distance from the target T1 to the virtual camera VC11 becomes shorter. When the virtual camera VC11 is rotated, at least one of pan rotation or tilt rotation is performed.

In the example shown in FIG. 10, in particular, a camera path is generated by combining rotation such as pan rotation and tilt rotation of the virtual camera VC11 and translation of the virtual camera VC11.

In this way, by setting the movement path so that it moves away from the viewpoint position P0 to the viewpoint position Pm and then approaches the viewpoint position P1′, the average rotation speed of the virtual camera VC11 can be kept smaller than the case of rotating the virtual camera VC11 while moving the virtual camera VC11 linearly or rotating the virtual camera VC11 without moving the virtual camera VC11. As a result, it is possible to reduce visually induced motion sickness when viewing the free-viewpoint video.

Moreover, in this case, since the virtual camera VC11 is moved to the viewpoint position Pm so as to move away from the target T0 and the target T1, the size of the target T0 and the target T1 in the free-viewpoint video is temporarily reduced, and the visually induced motion sickness can be further reduced. Additionally, it becomes possible for the user to easily grasp the viewpoint position, and it is possible to easily achieve the free viewpoint movement desired by the user.

Moreover, by combining translation and rotation of the virtual camera VC11 when generating the camera path, the new target T1 can be included in the angle of view of the virtual camera VC11 more promptly than when only rotation is performed. As a result, a new target T1 can be presented to the user promptly, and the user's satisfaction level can be improved.

Note that the rotation angle of the virtual camera VC11 at the end point of the camera path may be different from an ideal rotation angle such as the optimum rotation angle for imaging the target T1 from the substantial front, for example, the initial rotation angle R1, or a rotation angle designated by the user.

In such a case, in the example shown in FIG. 10, for example, after the virtual camera VC11 reaches the viewpoint position P1′, the control unit 24 may rotate the virtual camera VC11 slowly, so that the rotation angle of the virtual camera VC11 changes from the rotation angle R1′ to the ideal rotation angle. That is, a camera path may be generated so that the virtual camera VC11 is further rotated at the viewpoint position P1′ after reaching the viewpoint position P1′.

Alternatively, in step S12 of FIG. 9, for example, the viewpoint position P1=P0 may be set. In this case, if the rotation speed rot is equal to or less than the threshold value th, the virtual camera will be rotated so that the rotation angle changes from R0 to R1 while the virtual camera remains at the viewpoint position P0, that is, the distance from the target T0 is maintained at a certain distance. When the virtual camera is rotated, at least one of pan rotation or tilt rotation is performed.

On the other hand, if the rotation speed rot is larger than the threshold value th, the virtual camera is rotated while the virtual camera is moved away from the target T0, as described with reference to FIG. 10, for example. When the virtual camera is rotated at this time, too, at least one of pan rotation or tilt rotation is performed.

<Modification 1>

<Reduction of Visually Induced Motion Sickness Caused by Pixel Movement>

Incidentally, in the camera path generation processing described with reference to FIG. 9, prevention of visually induced motion sickness mainly focusing on the rotation of the virtual camera has been described.

However, even if the rotation of the virtual camera is not large, visually induced motion sickness is also caused by large pixel movement in the free-viewpoint video. Pixel movement is the amount of movement of corresponding pixels between free-viewpoint videos (frames) at different times.

As a factor that increases the pixel movement in the free-viewpoint video, that is, in the screen, it is conceivable that there is an object near the virtual camera. The object referred to here is a target T0 or a target T1 which is a target of attention (target of interest), for example.

If the pixel movement is large and visually induced motion sickness is likely to occur, it is possible to reduce the visually induced motion sickness by moving the virtual camera to a position a certain distance away from the target T0 or the target T1 and generating a camera path that reduces pixel movement, for example.

In such a case, for example, in step S18 of FIG. 9, a control unit 24 determines a midpoint Pm as shown in FIG. 10, and then obtains the pixel difference on the basis of a free-viewpoint video IMG0 at a viewpoint position P0 and a free-viewpoint video IMGm at the midpoint Pm, that is, at a viewpoint position Pm.

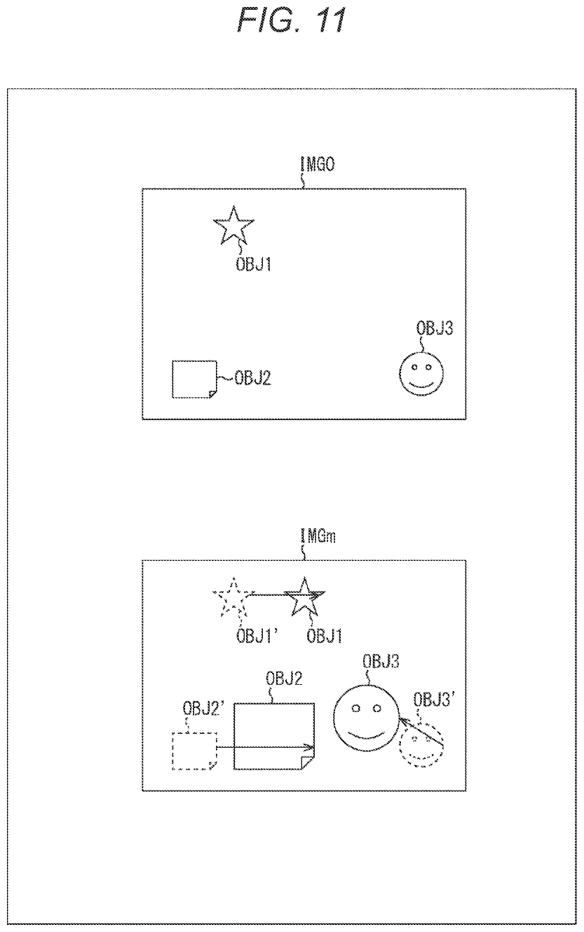

The pixel difference is an index indicating the magnitude of pixel movement between frames of the free-viewpoint video, and the control unit 24 detects feature points from the free-viewpoint video IMG0 before movement and the free-viewpoint video IMGm after movement as shown in FIG. 11, for example.

In the example shown in FIG. 11, multiple objects including a target, that is, multiple objects OBJ1 to OBJ3 exist in the free-viewpoint video IMG0. Additionally, the multiple objects OBJ1 to OBJ3 also exist in the free-viewpoint video IMGm after movement.

Note that in FIG. 11, objects OBJ1′ to OBJ3′ drawn by the dotted lines in the free-viewpoint video IMGm represent the objects OBJ1 to OBJ3 before movement, that is, those in the free-viewpoint video IMG0.

It is assumed that many common objects appear in the free-viewpoint video IMG0 before movement and the free-viewpoint video IMGm after movement. When calculating the pixel difference, if feature points are detected for the free-viewpoint video IMG0 and the free-viewpoint video IMGm, many feature points are detected from the objects OBJ1 to OBJ3 that appear as subjects, for example.

The control unit 24 associates the feature points detected from the free-viewpoint video IMG0 with the feature points detected from the free-viewpoint video IMGm. Then, the control unit 24 obtains the amount of movement of the feature points on the free-viewpoint video between the free-viewpoint video IMG0 and the free-viewpoint video IMGm for each of the associated feature points, and sets the total value of the amount of movement of the feature points as the pixel difference value.

Note that if a predetermined number or more corresponding feature points are not detected in the free-viewpoint video IMG0 and the free-viewpoint video IMGm, the pixel movement is considered to be extremely large, and the pixel difference is set to a very large value determined in advance.

For example, in a case where an object in the free-viewpoint video is moving at high speed and a common object is not included in the free-viewpoint video IMG0 and the free-viewpoint video IMGm, the number of corresponding feature points in the free-viewpoint video IMG0 and the free-viewpoint video IMGm may be less than the predetermined number.

When the control unit 24 obtains the pixel difference, the control unit 24 compares the obtained pixel difference with a predetermined threshold value thd. Then, if the pixel difference is equal to or less than the threshold value thd, the control unit 24 considers that the pixel movement is sufficiently small and visually induced motion sickness is less likely to occur. Hence, the control unit 24 generates a camera path on the basis of the viewpoint position P0 and a rotation angle R0, the viewpoint position Pm and a rotation angle Rm, and a viewpoint position P1′ and a rotation angle R1′.

On the other hand, if the pixel difference is larger than the threshold value thd, the control unit 24 defines a position farther from the target T0 and the target T1 than the viewpoint position Pm as a viewpoint position Pm′.

For example, how far the viewpoint position Pm′ is from the target T0 and the target T1 may be determined on the basis of the pixel difference value or the like. Additionally, for example, the viewpoint position Pm′ may be set to a position separated from the viewpoint position Pm by a predetermined distance.

Further, the control unit 24 determines a rotation angle Rm′ at which the target T0 and the target T1 are included in the angle of view of the virtual camera at the viewpoint position Pm′.

It can be said that the viewpoint position Pm′ and the rotation angle Rm′ are modifications of the viewpoint position Pm and the rotation angle Rm. In other words, it can be said that determining the viewpoint position Pm′ and the rotation angle Rm′ is equivalent to redetermining the viewpoint position Pm and the rotation angle Rm, that is, the angle of view of the virtual camera on the basis of the amount of movement of the corresponding feature points between the free-viewpoint videos at different timings (times).

Note that when correcting the viewpoint position Pm and the rotation angle Rm, the viewpoint position Pm′ and the rotation angle Rm′ are determined so that the pixel difference between the free-viewpoint video IMG0 and the free-viewpoint video at the viewpoint position Pm′ is equal to or less than the threshold value thd.

After the viewpoint position Pm′ and the rotation angle Rm′ are determined, the control unit 24 generates a camera path on the basis of the viewpoint position P0 and the rotation angle R0, the viewpoint position Pm′ and the rotation angle Rm′, and the viewpoint position P1′ and the rotation angle R1′.

In this case, as in the case of FIG. 10, for example, a camera path is generated in which the virtual camera moves from the viewpoint position P0 to the viewpoint position Pm′ and further moves from the viewpoint position Pm′ to the viewpoint position P1′. Additionally, in this case, the rotation angle of the virtual camera changes from R0 to Rm′, and then further changes from Rm′ to R1′.

By determining the midpoint so that the pixel difference is equal to or less than the threshold value thd as described above, it is possible to reduce not only the visually induced motion sickness caused by the rotation of the virtual camera, but also the visually induced motion sickness caused by pixel movement.

Note that while an example has been described in which the pixel difference and the threshold value thd are compared in step S18 of FIG. 9 and the viewpoint position Pm and the rotation angle Rm are appropriately corrected to the viewpoint position Pm′ and the rotation angle Rm′, similar processing may be performed in step S15.

Moreover, in the camera path generation processing, after the processing of step S12 of FIG. 9 is performed, the viewpoint position Pm and the rotation angle Rm may be determined with respect to the viewpoint position P0 and the rotation angle R0 and the viewpoint position P1 and the rotation angle R1, and then the pixel difference and the threshold value thd may be compared.

In this case, if the pixel difference is equal to or less than the threshold value thd, a camera path is generated on the basis of the viewpoint position P0 and the rotation angle R0, the viewpoint position Pm and the rotation angle Rm, and the viewpoint position P1 and the rotation angle R1.

On the other hand, if the pixel difference is larger than the threshold value thd, the viewpoint position Pm′ and the rotation angle Rm′ are defined, and a camera path is generated on the basis of the viewpoint position P0 and the rotation angle R0, the viewpoint position Pm′ and the rotation angle Rm′, and the viewpoint position P1 and the rotation angle R1.

In addition, at the viewpoint position Pm, it is not necessary that both the target T0 and the target T1 are included in the angle of view of the virtual camera. Even when not both of the target T0 and the target T1 are included in the angle of view of the virtual camera, if the pixel difference is larger than the threshold thd, the viewpoint position Pm′ and rotation angle Rm′ are determined so that the pixel difference is equal to or less than the threshold value thd.

This is because in a case where the distance from the target T0 or the target T1 to the viewpoint position Pm is equal to or less than a certain distance and a certain percentage of the area in the free-viewpoint video, that is, in the screen is covered by the target T0 or the target T1, the pixel movement becomes large. Even in such a case, by moving the virtual camera to the viewpoint position Pm′ away from the target T0 and the target T1, it is possible to reduce the visually induced motion sickness caused by the pixel movement.

<Modification 2>

<Description of Camera Path Generation Processing>

Incidentally, in the above, an example of generating a camera path in which the viewpoint position and the rotation angle of the virtual camera continuously change has been described. However, depending on the positional relationship between a target T0 and a target T1, the viewpoint position and the rotation angle of the virtual camera may be changed discontinuously, and successive free-viewpoint videos changing discontinuously may be connected by an image effect such as fade-in.

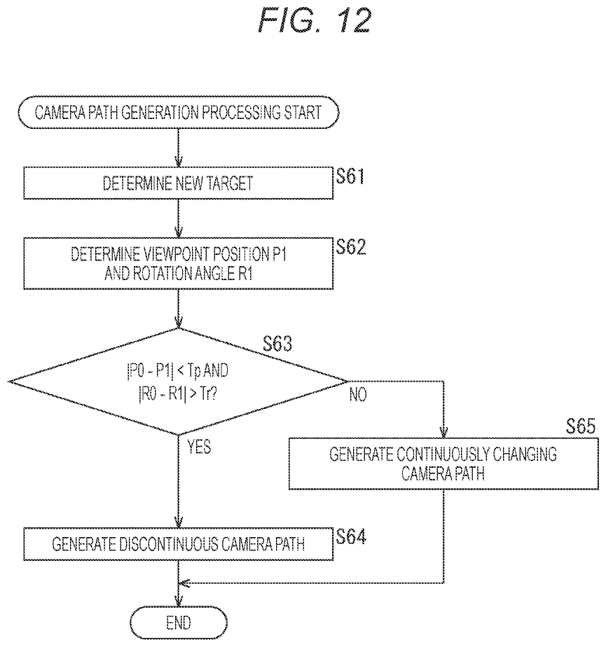

In such a case, an information processing device 11 generates a camera path by performing camera path generation processing shown in FIG. 12, for example. Hereinafter, camera path generation processing by the information processing device 11 will be described with reference to the flowchart of FIG. 12.

Note that the processing of steps S61 and S62 in FIG. 12 is similar to the processing of steps S11 and S12 of FIG. 9, and the description thereof will be omitted.

In step S63, the control unit 24 determines whether or not |P0−P1|<Tp and |R0−R1|>Tr. That is, it is determined whether or not |P0−P1|, which is the absolute difference between viewpoint positions P0 and P1, is less than a predetermined threshold value Tp, and |R0−R1|, which is the absolute difference between rotation angles R0 and R1, is larger than a predetermined threshold value Tr.

In other words, in step S63, it is determined whether or not the relationship between the angle of view of the virtual camera at the start point of the camera path and the angle of view of the virtual camera at the end point of the camera path satisfies the condition |P0−P1|<Tp and |R0−R1|>Tr.

For example, whether or not the condition |P0−P1|<Tp and |R0−R1|>Tr is satisfied is determined by the positional relationship and the like among the viewpoint position P0, the viewpoint position P1, the target T0, and the target T1.

The condition |P0−P1|<Tp is established when the distance from the viewpoint position P0 to the viewpoint position P1 is shorter than the predetermined distance Tp. Additionally, the condition |R0−R1|>Tr is established when the angle formed by the orientation (direction) of the virtual camera indicated by the rotation angle R0 and the orientation of the virtual camera indicated by the rotation angle R1 is larger than a predetermined angle Tr.

When |P0−P1|<Tp and |R0−R1|>Tr, the distance between the viewpoint position P0 and the viewpoint position P1 is short, and the amount of rotation for rotating the virtual camera from the rotation angle R0 to the rotation angle R1 is large (rotation is large), and therefore the rotation speed of the virtual camera becomes large.

Accordingly, |P0−P1|<Tp and |R0−R1|>Tr is equivalent to the above-mentioned case in which the average rotation speed of the virtual camera is larger than the threshold value th. Hence, when |P0−P1|<Tp and |R0−R1|>Tr, if a camera path is generated in which the viewpoint position moves from P0 to P1 and the rotation angle changes from R0 to R1, visually induced motion sickness may occur.

Therefore, in this example, when |P0−P1|<Tp and |R0−R1|>Tr, the occurrence of visually induced motion sickness is prevented by generating a discontinuous camera path.

That is, if it is determined in step S63 that |P0−P1|<Tp and |R0−R1|>Tr, the control unit 24 generates a discontinuous camera path in step S64, and the camera path generation processing ends.

That is, the control unit 24 generates a camera path in which the state where the viewpoint position of the virtual camera is P0 is switched to the state where it is P1, and the state where the rotation angle of the virtual camera is R0 is also switched to the state where it is R1. In other words, a camera path is generated in which the angle of view of the virtual camera is switched to another angle of view.

Thereafter, when the control unit 24 generates a free-viewpoint video according to the obtained camera path, the control unit 24 performs fade processing on the free-viewpoint video. As a result, in the generated free-viewpoint video, the state in which the video captured by the virtual camera in a state ST0 is displayed gradually changes to the state in which the video captured by the virtual camera in a state ST1 is displayed. Note that in addition to the fade processing, other image effect processing may be applied to the free-viewpoint video.

When switching the state (angle of view) of the virtual camera discontinuously, the virtual camera does not rotate continuously, so that the average rotation speed of the virtual camera becomes equal to or less than the threshold value th, and the occurrence of visually induced motion sickness can be prevented. Moreover, since the videos are gradually switched by image effects such as fading, not only is it less likely to cause visually induced motion sickness, but it is also possible to obtain high-quality free-viewpoint videos that look better than when the videos are suddenly switched.

On the other hand, if it is determined in step S63 that |P0−P1|<Tp and |R0−R1|>Tr is not established, in step S65, the control unit 24 generates a camera path in which the viewpoint position and the rotation angle of the virtual camera change continuously, and the camera path generation processing ends. For example, in step S65, similar processing as in step S15 of FIG. 9 is performed to generate a camera path.

As described above, the information processing device 11 generates a camera path in which the state of the virtual camera changes discontinuously according to the distance between the viewpoint positions before and after the movement and the amount of change in the rotation angle of the virtual camera before and after the movement. As a result, it is possible to reduce visually induced motion sickness of the free-viewpoint video.

Note that switching of the camera path generation algorithm, that is, whether to generate a discontinuous camera path or a continuous camera path may be determined by a display unit 12 which is a viewing device for free-viewpoint videos, or be determined depending on the susceptibility of the user who is the viewer to motion sickness.

Specifically, for example, even when viewing the same free-viewpoint video, the susceptibility to visually induced motion sickness differs depending on the characteristics of the viewing device such as the viewing mode by the viewing device and the display screen size of the viewing device.

Here, the viewing mode by the viewing device refers to how the user who is the viewer views the free-viewpoint video, such as viewing with the viewing device attached to the head or viewing with the viewing device installed.

For example, in a case where a television is used as a viewing device, even if there is a viewpoint movement such that the direction of the virtual camera rotates 180 degrees on the screen, the user who is watching the free-viewpoint video on the television is less likely to experience visually induced motion sickness.

This is because when viewing a free-viewpoint video on a television, the user's eyes can see things around the television other than the free-viewpoint video. In other words, only the part of the free-viewpoint video that is part of the user's field of view rotates.

Hence, in a case where the viewing device is a television, for example, the threshold value Tp described above can be decreased to some extent and the threshold value Tr can be increased to some extent.

On the other hand, in a case where an HMD is used as a viewing device, for example, the entire field of view of the user becomes a free-viewpoint video, and if the virtual camera rotates significantly in a short time, visually induced motion sickness will occur. Hence, a discontinuous camera path should be generated in such a case. Hence, in a case where the viewing device is an HMD, for example, it is better to increase the threshold value Tp to some extent and decrease the threshold value Tr to some extent.

Thus, when the same free-viewpoint video can be viewed on different types of viewing devices such as a smartphone, a television, and an HMD, a different threshold value Tp and threshold value Tr may be set in advance for each characteristic of the viewing device. Then, with the camera path generation processing described with reference to FIG. 12, it possible to generate an appropriate camera path according to the characteristics of the viewing device. Similarly, the user may be allowed to change the threshold value Tp and the threshold value Tr according to the susceptibility of an individual to motion sickness or the like.

<Modification 3>

<Description of Camera Path Generation Processing>

Moreover, when generating a camera path, the movement speed (movement) of a target T0 or a target T1 of interest may be taken into consideration.

For example, when generating a camera path that achieves camera work that keeps a new target T1 within the angle of view of the virtual camera, when the movement of the target T1 is large, the target T1 can always be included in the angle of view of the virtual camera by maintaining a certain distance between the target T1 and a viewpoint position P1.

In particular, when the movement of the target T1 is large, if the target T1 appears large in the free-viewpoint video, visually induced motion sickness caused by the pixel movement described above is likely to occur. Hence, for the target T1 with large movement, by increasing the distance from the target T1 to the viewpoint position P1, it is possible not only to prevent the target T1 from going out of the angle of view, but also to curb visually induced motion sickness.

On the other hand, when the movement of the target T1 is small, it is less likely that the target T1 will go out of the angle of view even if the distance from the target T1 to the viewpoint position P1 is shortened to some extent, and visually induced motion sickness is less likely to occur. What is more, in this case, the target T1 appears large in the free-viewpoint video, and a good-looking video can be obtained.

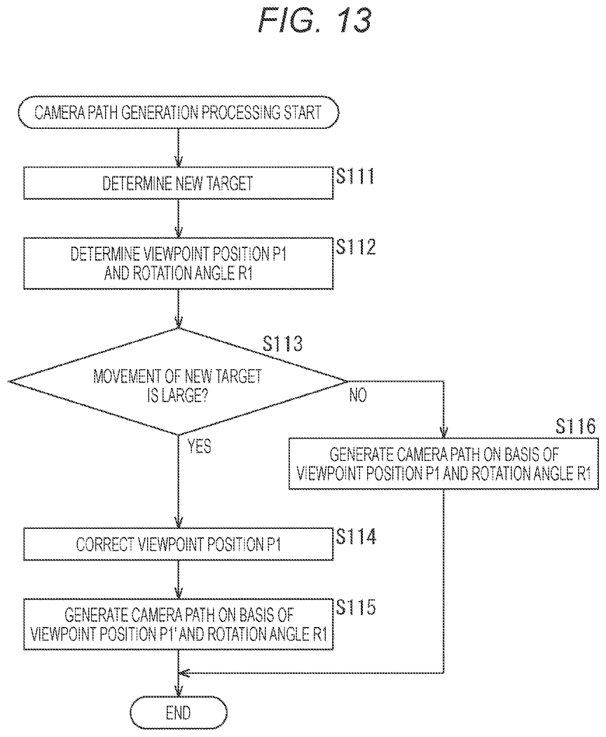

In this way, in a case of generating the camera path in consideration of the movement speed of the target T1, that is, the movement of the target T1, an information processing device 11 performs camera path generation processing shown in FIG. 13, for example. Hereinafter, camera path generation processing by the information processing device 11 will be described with reference to the flowchart of FIG. 13.

Note that the processing of steps S111 and S112 in FIG. 13 is similar to the processing of steps S11 and S12 of FIG. 9, and the description thereof will be omitted.

In step S113, a control unit 24 determines whether or not the movement of the new target T1 is large on the basis of content data supplied from a content data acquisition unit 21.

For example, the control unit 24 obtains the movement speed of the target T1 at the time when the virtual camera reaches a viewpoint position P1 on the basis of the content data, and if the movement speed is equal to or higher than a predetermined threshold value, determines that the movement of the target T1 is large.

For example, the movement speed of the target T1 can be obtained by pre-reading the content data. However, in a case where it is difficult to pre-read the content data, such as a case where the content of the free-viewpoint video is delivered in real time, the movement speed of the target T1 is obtained by predicting on the basis of the content data before the timing when the virtual camera reaches the viewpoint position P1.

If it is determined in step S113 that the movement of the target T1 is large, in step S114, the control unit 24 corrects the viewpoint position P1 determined in step S112 on the basis of the movement speed of the target T1, and obtains a viewpoint position P1′. That is, the viewpoint position P1 is redetermined on the basis of the movement speed of the target T1.

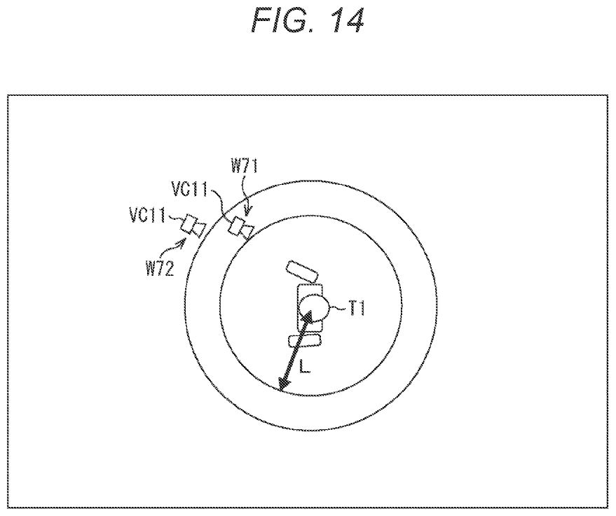

Specifically, for example, as shown in FIG. 14, it is assumed that the viewpoint position P1 obtained in step S112 is a position separated from the target T1 by a distance L. Note that in FIG. 14, the same reference numerals are given to the parts corresponding to those in FIG. 10, and the description thereof will be omitted as appropriate.

In FIG. 14, the position indicated by an arrow W71 is the viewpoint position P1 before correction of a virtual camera VC11. When the movement of the target T1 is large, if the target T1 continues to move even after the virtual camera VC11 reaches the viewpoint position P1, the target T1 may move out of the angle of view of the virtual camera VC11.

Hence, the control unit 24 defines a position farther from the target T1 than the viewpoint position P1 as the viewpoint position P1′ on the basis of the movement speed of the target T1. Here, the position indicated by an arrow W72 is the viewpoint position P1′.

For example, assume that the target T1 is moving even after the virtual camera VC11 reaches the viewpoint position P1, and the moving range of the target T1 is predicted on the basis of the movement speed of the target T1. Additionally, on the basis of the prediction result, a range in which the above-mentioned appropriate distance L can be secured as the distance from the virtual camera VC11 to the target T1 is obtained, and an appropriate position within that range is defined as the viewpoint position P1′.

Thus, in a case where the movement of the target T1 is large, the viewpoint position P1′ is determined on the basis of the movement (movement speed) of the target T1. In other words, the angle of view of the virtual camera VC11 at the end point of the camera path is determined on the basis of the movement of the target T1.

Returning to the description of FIG. 13, in step S115, the control unit 24 generates a camera path on the basis of the viewpoint position P1′ and a rotation angle R1, and the camera path generation processing ends.

That is, the control unit 24 generates a camera path in which the virtual camera moves from a viewpoint position P0 to the viewpoint position P1′ and the virtual camera rotates from the direction indicated by a rotation angle R0 to the direction indicated by the rotation angle R1.

At this time, if the target T0 or target T1 is moving, the position of the target T0 or target T1 at each timing (time) is predicted on the basis of the content data, and the camera path is generated in consideration of the prediction result as well.

By using the camera path obtained in this way, the target T1 can be appropriately captured by the virtual camera even when the target T1 is moving. In other words, the target T1 can be included in the angle of view of the virtual camera.

On the other hand, if it is determined in step S113 that the movement of the target T1 is not large, the control unit 24 generates a camera path on the basis of the viewpoint position P1 and the rotation angle R1 in step S116, and the camera path generation processing ends. In this case, in step S116, a camera path is generated in a similar manner as in step S15 of FIG. 9.

As described above, the information processing device 11 generates a camera path in consideration of the movement of the new target T1 as well. As a result, the target T1 can be appropriately included in the angle of view of the virtual camera, and visually induced motion sickness can be reduced. In particular, in this case, the viewpoint position can be set to a position separated from the target T1 by an appropriate distance depending on whether the movement of the target T1 is large or the movement of the target T1 is small.

Note that in a case of generating a camera path that achieves camera work that keeps the new target T1 within the angle of view of the virtual camera, the distance between the virtual camera and the target may change depending on whether or not there are other targets within a certain distance from the target T0 or target T1.

For example, if there is no other target in the vicinity of the new target T1, the control unit 24 determines the viewpoint position P1 so that the target T1 is kept within the angle of view of the virtual camera and the target T1 appears sufficiently large in the free-viewpoint video.

On the other hand, for example, if there is another target T2 in the vicinity of the new target T1, the control unit 24 determines a position separated from the target T1 to some extent as the viewpoint position P1, so that the target T1 and the target T2 are within the angle of view of the virtual camera.

As a result, it is possible to obtain a good-looking video in which one or more targets appear in an appropriate size in the free-viewpoint video.

<Computer Configuration Example>

Incidentally, the series of processing described above can be performed by hardware or software. In a case where the series of processing is performed by software, a program that is included in the software is installed on a computer. Here, the computer includes a computer incorporated in dedicated hardware, a general-purpose personal computer, for example, that can execute various functions by installing various programs, and the like.

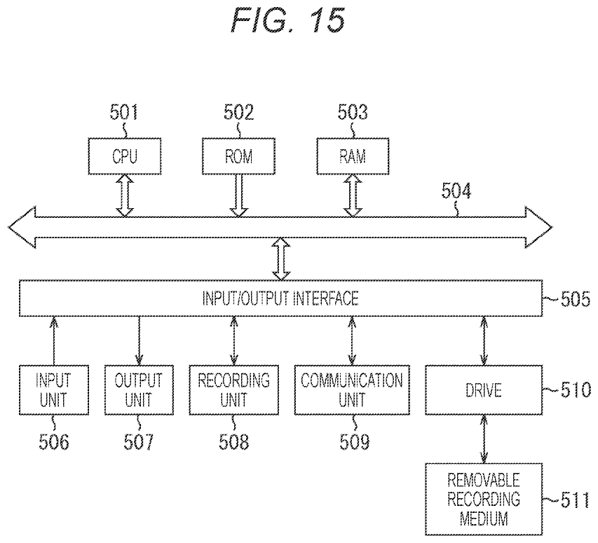

FIG. 15 is a block diagram showing a hardware configuration example of a computer that executes the series of processing described above according to a program.

In the computer, a CPU 501, a read only memory (ROM) 502, and a RAM 503 are connected to each other by a bus 504.

An input/output interface 505 is also connected to the bus 504. An input unit 506, an output unit 507, a recording unit 508, a communication unit 509, and a drive 510 are connected to the input/output interface 505.

The input unit 506 includes a keyboard, a mouse, a microphone, an imaging device, and the like. The output unit 507 includes a display, a speaker, and the like. The recording unit 508 includes a hard disk, a nonvolatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, for example, the CPU 501 loads a program recorded in the recording unit 508 to the RAM 503 through the input/output interface 505 and the bus 504, and executes the program to perform the above-described series of processing.

The program executed by the computer (CPU 501) can be provided by being recorded on the removable recording medium 511 such as a package medium, for example. Additionally, the program can be provided through a wired or wireless transmission medium such as a local area network, the Internet, or digital satellite broadcasting.

In the computer, the program can be installed in the recording unit 508 through the input/output interface 505 by attaching the removable recording medium 511 to the drive 510. Additionally, the program can be received by the communication unit 509 through a wired or wireless transmission medium and be installed in the recording unit 508. In addition, the program can be installed in advance in the ROM 502 or the recording unit 508.

Note that the program executed by the computer may be a program that performs processing in chronological order according to the order described in the present specification, or a program that performs processing in parallel, or at a necessary timing such as when a call is made.

Additionally, the embodiment of the present technology is not limited to the above-described embodiment, and various modifications can be made without departing from the scope of the present technology.

For example, the present technology can have a cloud computing configuration in which one function is shared and processed by multiple devices through a network.

Additionally, each step described in the above-described flowchart can be executed by one device or be executed in a shared manner by multiple devices.

Moreover, in a case where multiple processes are included in one step, the multiple processes included in one step can be executed by one device or be executed in a shared manner by multiple devices.

Moreover, the present technology can also be configured in the following manner.

(1)

An information processing device including

an input acquisition unit that acquires user input that designates a display range of a free-viewpoint video, and

a control unit that controls a virtual camera that determines the display range of the free-viewpoint video on the basis of the user input, in which

when the control unit changes an angle of view of the virtual camera from a first angle of view including a first target to a second angle of view including a second target in response to the user input,

if at least one of pan rotation or tilt rotation of the virtual camera has a predetermined angular velocity, the control unit performs at least one of the pan rotation or the tilt rotation of the virtual camera while moving the virtual camera away from the first target, and

if the angular velocity of the pan rotation and the tilt rotation of the virtual camera is smaller than the predetermined angular velocity, the control unit performs at least one of the pan rotation or the tilt rotation of the virtual camera while maintaining the distance between the virtual camera and the first target.

(2)

The information processing device according to (1), in which

the control unit determines the second angle of view on the basis of the user input.

(3)

The information processing device according to (2), in which

if the angular velocity of at least one of the pan rotation or the tilt rotation of the virtual camera is the predetermined angular velocity larger than a predetermined threshold value, the control unit redetermines the second angle of view so that the angular velocity of the pan rotation and the tilt rotation of the virtual camera is equal to or less than the threshold value.

(4)

The information processing device according to (3), in which

when the control unit redetermines the second angle of view, the control unit performs at least one of the pan rotation or the tilt rotation of the virtual camera while moving the virtual camera away from the first target, so that the angle of view of the virtual camera changes from the first angle of view to the redetermined second angle of view.

(5)

The information processing device according to (4), in which

when the control unit redetermines the second angle of view, the control unit moves the virtual camera away from the first target so that the angle of view of the virtual camera changes from the first angle of view to a third angle of view, and then moves the virtual camera so that the angle of view of the virtual camera changes from the third angle of view to the second angle of view.

(6)

The information processing device according to (5), in which

the control unit determines the third angle of view, so that the first target and the second target are included in the third angle of view.

(7)

The information processing device according to (6), in which

the control unit determines the third angle of view on the basis of an amount of movement of corresponding feature points between the free-viewpoint videos at different times.

(8)

The information processing device according to any one of (1) to (7), in which

the control unit moves the virtual camera from a position corresponding to the first angle of view to a position corresponding to the second angle of view while keeping the virtual camera away from the first target and the second target by a certain distance or more.

(9)

The information processing device according to any one of (1) to (8), in which

when a relationship between the first angle of view and the second angle of view satisfies a predetermined condition, the control unit switches the angle of view of the virtual camera from the first angle of view to the second angle of view, and performs fade processing, so that the free-viewpoint video of the first angle of view gradually changes to the free-viewpoint video of the second angle of view.

(10)

The information processing device according to (9), in which

when a distance from the position corresponding to the first angle of view of the virtual camera to the position corresponding to the second angle of view of the virtual camera is shorter than a predetermined distance and an angle formed by a direction corresponding to the first angle of view of the virtual camera and a direction corresponding to the second angle of view of the virtual camera is larger than a predetermined angle, it is considered that the predetermined condition is satisfied.

(11)

The information processing device according to any one of (2) to (7), in which

the control unit determines the second angle of view on the basis of the user input and a movement of the first target.

(12)

An information processing method including

acquiring user input that designates a display range of a free-viewpoint video, and

when changing an angle of view of a virtual camera that determines the display range of the free-viewpoint video in response to the user input from a first angle of view including a first target to a second angle of view including a second target,

if at least one of pan rotation or tilt rotation of the virtual camera has a predetermined angular velocity, performing at least one of the pan rotation or the tilt rotation of the virtual camera while moving the virtual camera away from the first target, and

if the angular velocity of the pan rotation and the tilt rotation of the virtual camera is smaller than the predetermined angular velocity, performing at least one of the pan rotation or the tilt rotation of the virtual camera while maintaining the distance between the virtual camera and the first target by an information processing device.

(13)

A program that causes a computer to perform processing including the steps of

acquiring user input that designates a display range of a free-viewpoint video, and

when changing an angle of view of a virtual camera that determines the display range of the free-viewpoint video in response to the user input from a first angle of view including a first target to a second angle of view including a second target,

if at least one of pan rotation or tilt rotation of the virtual camera has a predetermined angular velocity, performing at least one of the pan rotation or the tilt rotation of the virtual camera while moving the virtual camera away from the first target, and

if the angular velocity of the pan rotation and the tilt rotation of the virtual camera is smaller than the predetermined angular velocity, performing at least one of the pan rotation or the tilt rotation of the virtual camera while maintaining the distance between the virtual camera and the first target.

### REFERENCE SIGNS LIST

11 Information processing device
12 Display unit
13 Sensor unit
21 Content data acquisition unit
22 Detection unit
23 Input acquisition unit
24 Control unit

1. An information processing device comprising
an input acquisition unit that acquires user input that designates a display range of a free-viewpoint video, and
a control unit that controls a virtual camera that determines the display range of the free-viewpoint video on a basis of the user input, wherein
when the control unit changes an angle of view of the virtual camera from a first angle of view including a first target to a second angle of view including a second target in response to the user input,
if at least one of pan rotation or tilt rotation of the virtual camera has a predetermined angular velocity, the control unit performs at least one of the pan rotation or the tilt rotation of the virtual camera while moving the virtual camera away from the first target, and
if the angular velocity of the pan rotation and the tilt rotation of the virtual camera is smaller than the predetermined angular velocity, the control unit performs at least one of the pan rotation or the tilt rotation of the virtual camera while maintaining the distance between the virtual camera and the first target.

2. The information processing device according to claim 1, wherein
the control unit determines the second angle of view on a basis of the user input.

3. The information processing device according to claim 2, wherein
if the angular velocity of at least one of the pan rotation or the tilt rotation of the virtual camera is the predetermined angular velocity larger than a predetermined threshold value, the control unit redetermines the second angle of view so that the angular velocity of the pan rotation and the tilt rotation of the virtual camera is equal to or less than the threshold value.

4. The information processing device according to claim 3, wherein
when the control unit redetermines the second angle of view, the control unit performs at least one of the pan rotation or the tilt rotation of the virtual camera while moving the virtual camera away from the first target, so that the angle of view of the virtual camera changes from the first angle of view to the redetermined second angle of view.

5. The information processing device according to claim 4, wherein
when the control unit redetermines the second angle of view, the control unit moves the virtual camera away from the first target so that the angle of view of the virtual camera changes from the first angle of view to a third angle of view, and then moves the virtual camera so that the angle of view of the virtual camera changes from the third angle of view to the second angle of view.

6. The information processing device according to claim 5, wherein
the control unit determines the third angle of view, so that the first target and the second target are included in the third angle of view.

7. The information processing device according to claim 6, wherein
the control unit determines the third angle of view on a basis of an amount of movement of corresponding feature points between the free-viewpoint videos at different times.

8. The information processing device according to claim 1, wherein
the control unit moves the virtual camera from a position corresponding to the first angle of view to a position corresponding to the second angle of view while keeping the virtual camera away from the first target and the second target by a certain distance or more.

9. The information processing device according to claim 1, wherein
when a relationship between the first angle of view and the second angle of view satisfies a predetermined condition, the control unit switches the angle of view of the virtual camera from the first angle of view to the second angle of view, and performs fade processing, so that the free-viewpoint video of the first angle of view gradually changes to the free-viewpoint video of the second angle of view.

10. The information processing device according to claim 9, wherein
when a distance from the position corresponding to the first angle of view of the virtual camera to the position corresponding to the second angle of view of the virtual camera is shorter than a predetermined distance and an angle formed by a direction corresponding to the first angle of view of the virtual camera and a direction corresponding to the second angle of view of the virtual camera is larger than a predetermined angle, it is considered that the predetermined condition is satisfied.

11. The information processing device according to claim 2, wherein
the control unit determines the second angle of view on a basis of the user input and a movement of the first target.

12. An information processing method comprising
acquiring user input that designates a display range of a free-viewpoint video, and
when changing an angle of view of a virtual camera that determines the display range of the free-viewpoint video in response to the user input from a first angle of view including a first target to a second angle of view including a second target,
if at least one of pan rotation or tilt rotation of the virtual camera has a predetermined angular velocity, performing at least one of the pan rotation or the tilt rotation of the virtual camera while moving the virtual camera away from the first target, and
if the angular velocity of the pan rotation and the tilt rotation of the virtual camera is smaller than the predetermined angular velocity, performing at least one of the pan rotation or the tilt rotation of the virtual camera while maintaining the distance between the virtual camera and the first target
by an information processing device.

13. A program that causes a computer to perform processing including the steps of
acquiring user input that designates a display range of a free-viewpoint video, and
when changing an angle of view of a virtual camera that determines the display range of the free-viewpoint video in response to the user input from a first angle of view including a first target to a second angle of view including a second target,
if at least one of pan rotation or tilt rotation of the virtual camera has a predetermined angular velocity, performing at least one of the pan rotation or the tilt rotation of the virtual camera while moving the virtual camera away from the first target, and
if the angular velocity of the pan rotation and the tilt rotation of the virtual camera is smaller than the predetermined angular velocity, performing at least one of the pan rotation or the tilt rotation of the virtual camera while maintaining the distance between the virtual camera and the first target.
